(19) United States
(12) Patent Application Publication
(10) Pub. No.: US 2017/0027130 A1
(43) Pub. Date: Feb. 2, 2017

(54) PET HIDEAWAYS

(71) Applicant: Greybull Innovation Ltd., Leicester (GB)

(72) Inventor: Darran Ainsley Thacker, Leicester (GB)

(21) Appl. No.: 15/219,440

(22) Filed: Jul. 26, 2016

(30) Foreign Application Priority Data
Jul. 30, 2015 (GB) 1513478.6

(51) Int. Cl. A01K 1/03; A01K 1/00

(52) U.S. Cl. CPC A01K 1/032; A01K 1/0076

(57) ABSTRACT

The present invention relates to a pet hideaway or shelter that is particularly suitable for use with pets that are typically kept in hutches or enclosures such as rabbits, guinea pigs, chinchillas, degus, hamsters etc. The hideaway comprises a plurality of substantially tubular modules connected together by connection means. Separate heating and/or cooling units can be inserted into the modules, which have a generally tubular construction.

### TECHNICAL FIELD

The present invention relates to hideaways (or shelters) suitable for use with pets that are typically kept in hutches or enclosures such as rabbits, guinea pigs, chinchillas, degus, hamsters etc.

### SUMMARY OF THE INVENTION

The present invention provides a pet hideaway (or shelter) comprising a plurality of substantially tubular modules connected together by connection means.

The hideaway can include any suitable number of modules.

The modules can be releasably connected together by the connection means. In other words, the modules can be separately formed and then connected together to define the hideaway. The user can optionally connect together a desired number of modules to construct a hideaway having a particular size.

The modules can be articulated together by the connection means so that the hideaway can be manipulated by a user to adopt different desired profiles.

Each module can include an integral connection part that allows it to be releasably connected to another module.

Each module can include a substantially-rigid hollow tubular body with at least one open end. The body or housing can be made from a suitable plastics material using any suitable process, e.g., vacuum moulding, extrusion etc. Plastics materials can be non-toxic and are hard-wearing, weatherproof and easy to keep clean.

The modules can be directly connected together such that adjacent modules that define the hideaway are in direct, physical, contact with each other. The direct connection can utilise the connection part that can optionally be an integral part of the body. The modules can have any suitable shape, size, cross-section etc.

The connection part can be formed such that, when two modules are releasably connected together, their respective connection parts are not in register with each other so that they do not hinder relative movement between the adjacent modules. In one arrangement, this can be achieved even if all of the modules have the same construction, by connecting adjacent modules together in an opposite orientation.

In another arrangement, the connection means can include a plurality of separate connection parts, each connection part being releasably connected to at least one module. The connection parts can be made from a suitable plastics material using any suitable process. Each connection part can be used to releasably connect two modules together.

Each connection part and at least part of each module can be provided with a complementary engagement profile or engagement means. The engagement profile can include a series of planar surfaces around the circumference of each module and complementary planar surfaces on each connection part.

The connection means is preferably adapted to substantially maintain the pet hideaway in the desired profile.

In one arrangement, at least a pair of adjacent modules are rotatably connected together. In other words, the connection means (e.g., an integral connection part or separate connection part) allows one module to rotate relative to an adjacent module. The modules can therefore be manipulated into different profiles by rotating or repositioning the modules such that the connection part of each module, or some other part, adopts a particular angular orientation with respect to the corresponding part of an adjacent module. The connection means and/or the module body can be adapted to limit relative rotation between adjacent modules to just one rotational direction, i.e., relative rotation is not permitted in the opposite rotational direction, or to limit relative movement between adjacent modules to just one movement direction.

The connection means and/or the module body can be adapted to temporarily maintain the hideaway in substantially the desired profile. For example, once the modules have been manipulated by the user to adopt a desired profile, the hideaway can be effectively maintained in the desired profile by the connection means until the user wants to manipulate the modules to a different profile. Some sort of temporary or user-activated locking means or retaining means can be provided. In practice, it may be that the hideaway is maintained in substantially the desired profile until a certain amount of force is applied by the user, at which point the modules will be articulated to a different profile under the action of that applied force. For example, in the case of friction contact between adjacent modules, a force greater than the static friction force must be applied if the user wants the hideaway to adopt a different profile. The hideaway is intended to be placed in a hutch or enclosure for use with pets such as rabbits, guinea pigs, chinchillas, degus, hamsters etc., and will preferably maintain the desired profile even if the pet climbs on top of the hideaway. In one arrangement, the complementary engagement profile or engagement means can increase the amount of force necessary to manipulate the hideaway so that the orientation of adjacent modules, and hence the overall hideaway, can be selectively maintained. In one arrangement, one or both of the connection means and the outer surface of the module body might be formed with a saw-tooth or ridged profile or the like that allows for relative rotation between the adjacent modules only when the necessary amount of force is applied. Such an engagement profile might also allow for relative rotation in one direction (e.g., clockwise) while completely preventing relative rotation in the opposite direction (e.g., counter-clockwise). In one arrangement, the engagement profile can include a series of flats or planar surfaces around the circumference of each module body or housing that are engaged by complementary planar surfaces of the connection means of an adjacent module or a separate connection means. The complementary planar surfaces prevent relative rotational movement between the adjacent modules to maintain the desired profile, and mean that adjacent modules can only be connected together at certain predetermined orientations by the connection means. The complementary planar surfaces permit lateral movement. The predetermined orientations will depend on the number of flats or planar surfaces provided on each module. The desired profile will normally be substantially ∩-shaped so that the hideaway forms an enclosed space in which small pets such as rabbits, guinea pigs, chinchillas, degus, hamsters etc. can conveniently shelter when the hideaway is placed in a hutch or enclosure.

The pet hideaway can further include at least one heating and/or cooling unit sized and shaped to be received within at least one module. It should be noted that some pets do not just require heating during cold weather. Some pets, and in particular guinea pigs, are unable to regulate their own body temperature, and can also require cooling during very hot weather. More than one module of the pet hideaway can include a heating and/or cooling unit. A module can receive two or more heating and/or cooling units, e.g., arranged end to end.

The at least one heating and/or cooling unit can be slidably received within the at least one module, e.g., through the at least one open end of the tubular body. Each heating and/or cooling unit can be sized and shaped to be received within the hollow interior of a respective module. Preferably each heating and/or cooling unit will be easily to install and remove. The heating and/or cooling units can be sold separately from the modules that define the basic hideaway structure, e.g., they are optional components.

The at least one heating and/or cooling unit can contain a thermal store in the form of a solid, liquid or gel responsive to heating or cooling externally applied to at least part of the unit (e.g., by placing the unit in a microwave or freezer) so that the solid, liquid or gel is heated or cooled, respectively, and remains in a heated or cooled state for a period of time after the externally applied heating or cooling is removed. During the period of time (e.g., a period of a few minutes up to a prolonged period of several hours), the unit can be used to provide heating or cooling for the pet using the hideaway. The amount of heating or cooling can be controlled by the user by altering the number of heating and/or cooling units that are installed in the hideaway. Heating and/or cooling units can be installed in a cluster of adjacent modules or more evenly distributed between the modules of the hideaway.

Each heating and/or cooling unit can include a substantially-rigid body that encloses the solid, liquid or gel material of the thermal store. The body can be made from any suitable material, e.g., a plastics material, using any suitable process.

The solid, liquid or gel that forms the thermal store can have any suitable composition and is preferably non-toxic so that it is suitable for use with pets. An example would be a gel composition using inter alia Carbopol®, propylene glycol, glycerine, ethyl paraben and water. Other suitable compositions, such as those used in conventional ‘hot and cold’ pads, will be known to the skilled person. Any suitable phase change material where heat is absorbed or released when the material changes from a solid to a liquid, or vice versa, can be used as the thermal store. The phase change material can have any suitable phase change temperature. Non-phase change material can also be used. In general, the term ‘thermal store’ should be interpreted broadly to include any solid, liquid or gel material that is capable of storing thermal energy and subsequently releasing the stored thermal energy to provide practically useful heating or cooling for a period of time after the externally applied heating or cooling is removed. It will be understood that such a definition includes phase change materials.

In one arrangement, the heating and/or cooling units can be heated or cooled for a particular period of time. For example, the units can be placed in a microwave (where the heating time will depend on the power of the microwave) or in a freezer. The units are then removed from the microwave or freezer and inserted into the modules, e.g., by sliding them into their hollow interiors. Each unit will remain in a heated or cooled state for a period of time after being removed from the microwave or freezer. Once the units have returned to ambient temperature, they can be removed from the modules and are ready to be heated or cooled again. The hideaway can be used with heating units in winter and cooling units in summer.

The pet hideaway can further include at least one heating unit sized and shaped to be received within at least one module, wherein the least one heating unit contains a supersaturated liquid or gel (e.g., sodium acetate trihydrate) and means (e.g., a trigger device that provides a nucleation site) for allowing the user to selectively initiate crystallisation of the supersaturated liquid or gel to release heat energy for a period of time. Again, the liquid or gel is preferably non-toxic. The at least one module can be reset by heating until all of the crystals have melted. Such modules generate their own heat energy as a result of the crystallisation process and external heating does not need to be applied.

The at least one heating unit can be slidably received within the at least one module. The heating unit can have a similar construction to the heating and/or cooling unit described above.

The present invention further provides a plurality of substantially tubular modules being adapted to be connected together to construct a pet hideaway that can preferably be manipulated by a user to adopt different desired profiles.

Each module can have the same construction.

Each module can include an integral connection part that allows it to be releasably connected directly to another module.

The present invention further provides a kit comprising a plurality of modules as described above and a plurality of connection parts, each connection part being adapted to be releasably connected to at least one module.

The kit can further include at least one heating and/or cooling unit sized and shaped to be received within at least one module. The at least one heating and/or cooling unit contains a thermal store in the form of a solid, liquid or gel responsive to heating or cooling externally applied to at least part of the unit so that the solid, liquid or gel is heated or cooled, respectively, and remains in a heated or cooled state for a period of time after the externally applied heating or cooling is removed. Other features of each heating and/or cooling unit can be as described above.

The present invention further includes a kit comprising a plurality of modules as described above and at least one heating unit sized and shaped to be received within at least one module, wherein the least one heating unit contains a supersaturated liquid or gel and means for allowing the user to selectively initiate crystallisation of the supersaturated liquid or gel to release heat energy for a period of time.

The hideaway can be covered by a cover in use. A cover with a waterproof or wipe-clean outer layer might be preferred. The cover can include an insulating inner layer. The heating and/or cooling units can also be placed inside a bag (e.g., a slide-lock bag) or other container for hygiene purposes before being placed in a microwave or freezer.

### DRAWINGS

FIG. 1 is a side view showing a pair of modules that can be connected together to form part of a pet hideaway according to the present invention;

FIG. 2 is a side view of the pair of modules of FIG. 1 connected together;

FIG. 3 is a side view of the pair of modules of FIGS. 1 and 2 rotated relative to each other to adopt a particular angular orientation;

FIG. 4 is a top view of the pair of modules of FIG. 1;

FIG. 5 is a top view of the pair of modules of FIG. 1 connected together;

FIG. 6 is a top view showing a pair of alternative modules that can be connected together to form part of a pet hideaway according to the present invention;

FIG. 7 is a top view of the pair of modules of FIG. 6 connected together;

FIG. 8 is a side view of a pet hideaway according to the present invention in a substantially ∩-shaped profile;

FIG. 9 is a top view of a pet hideaway according to the present invention in a substantially L-shaped profile;

FIG. 10 is a side view showing a pair of alternative modules that can be connected together to form part of a pet hideaway according to the present invention;

FIG. 11 is a side view of the pair of modules of FIG. 10 connected together; and

FIG. 12 is a side view of the pair of modules of FIGS. 10 and 11 rotated relative to each other to adopt a particular angular orientation.

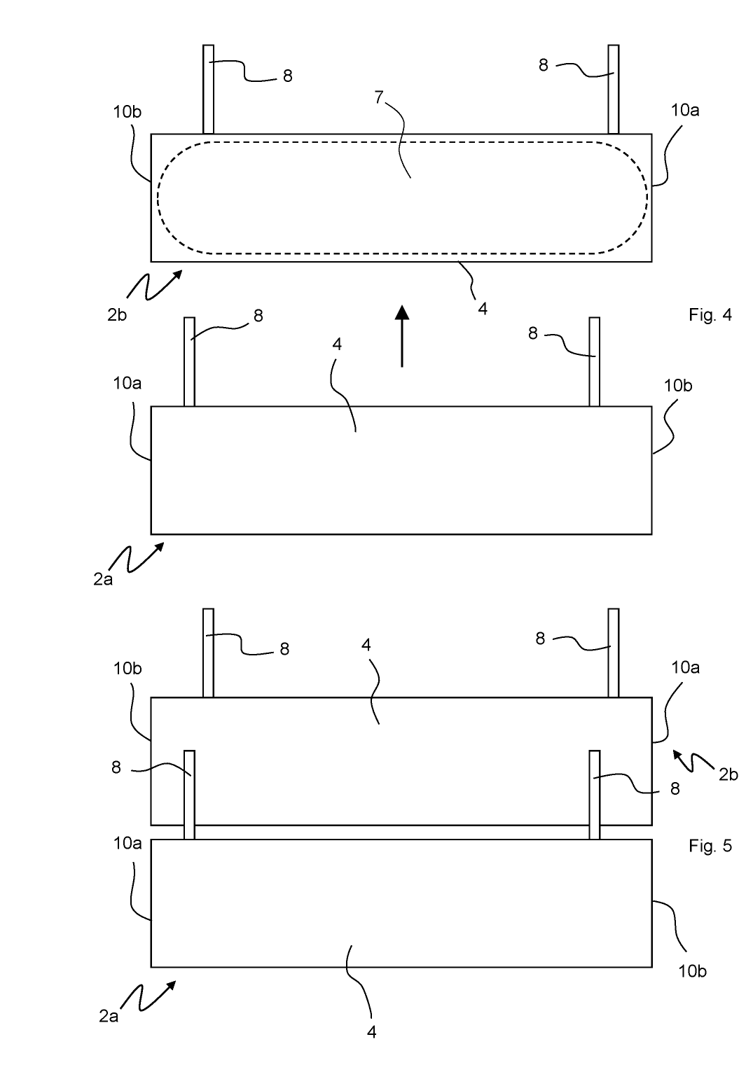

With reference to FIGS. 1 and 4, a module 2 for constructing a pet hideaway 1 according to the present invention includes a substantially cylindrical tubular body 4 made of a suitable plastics material and has a hollow interior 5 with openings at both ends of the body.

The module 2 includes a pair of integral connection parts 6 each having a pair of curved, resilient, arms 8. The connection parts 6 are spaced apart along the axial direction of the module 2 and each connection part is a different distance from the respective axial end of the module.

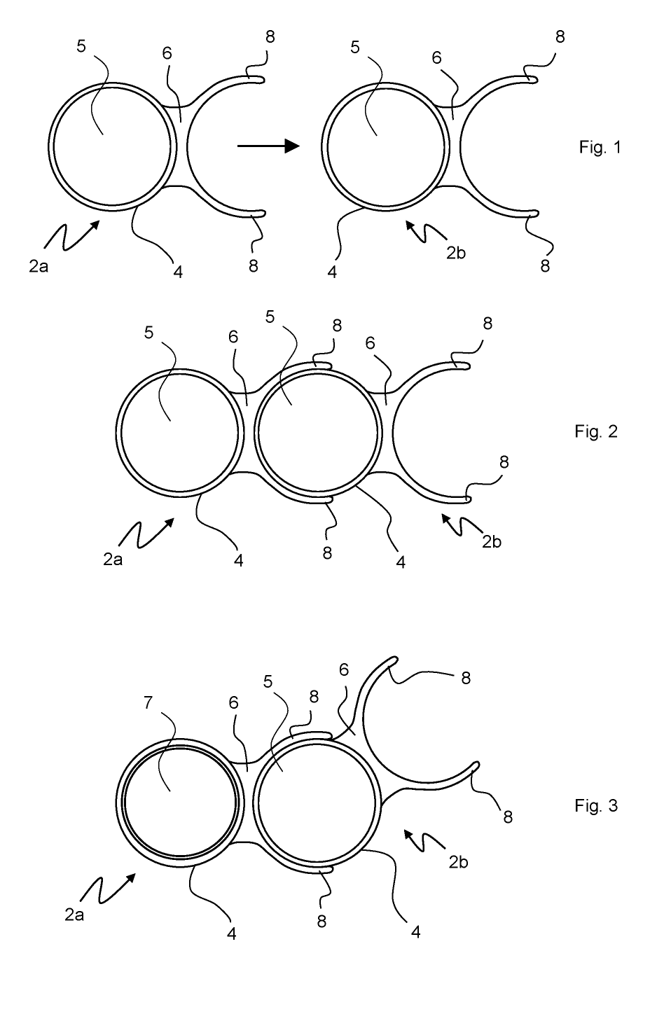

A plurality of modules 2 can be connected together using the connection parts 6 to form a hideaway. FIGS. 1 and 2 show how a pair of modules 2a, 2b can be connected together. The arms 8 are shaped to have an inner profile that corresponds to the outer profile of the body 4. The arms 8 of module 2a will flex outwardly as the adjacent module 2b is pushed into module 2a and then return to their initial position where they are in friction contact with the outer surface of the body 4 of the adjacent module 2b. It will be readily understood that a third module can be pushed into module 2b, and so on, until a hideaway containing the desired number of identical modules has been constructed.

Adjacent modules can be rotated relative to each other. This is shown in FIG. 3 where module 2b has been rotated relative to the connection parts 6 of module 2a so that the connection parts of the adjacent modules adopt a particular angular orientation with respect to each other.

FIGS. 3 and 4 also show a separate heating unit 7 inserted into the hollow interior 5 of the body 4 of module 2a and 2b, respectively. The heating unit 7 contains a thermal store, e.g., in the form of a non-toxic phase change material. In an alternative arrangement (not shown) the heating unit can contain a non-toxic supersaturated liquid or gel (e.g., sodium acetate trihydrate) and a trigger device that, when activated by the user, provides a nucleation site that initiates crystallisation of the supersaturated liquid or gel into a solid. The heating unit 7 can include a body made of a suitable plastics material that contains the phase change material. The phase change material can be inserted into the body through an opening (not shown) that is subsequently sealed or closed. The heating unit 7 is slid into the hollow interior 5 and is retained within the body 4 by friction contact between the outer cylindrical surface of the heating unit and the inner cylindrical surface of the body 4. In an alternative arrangement, some sort of locking or retaining means might be provided on the heating unit and/or the body of the module to temporarily retain the heating unit in position until it needs to be removed.

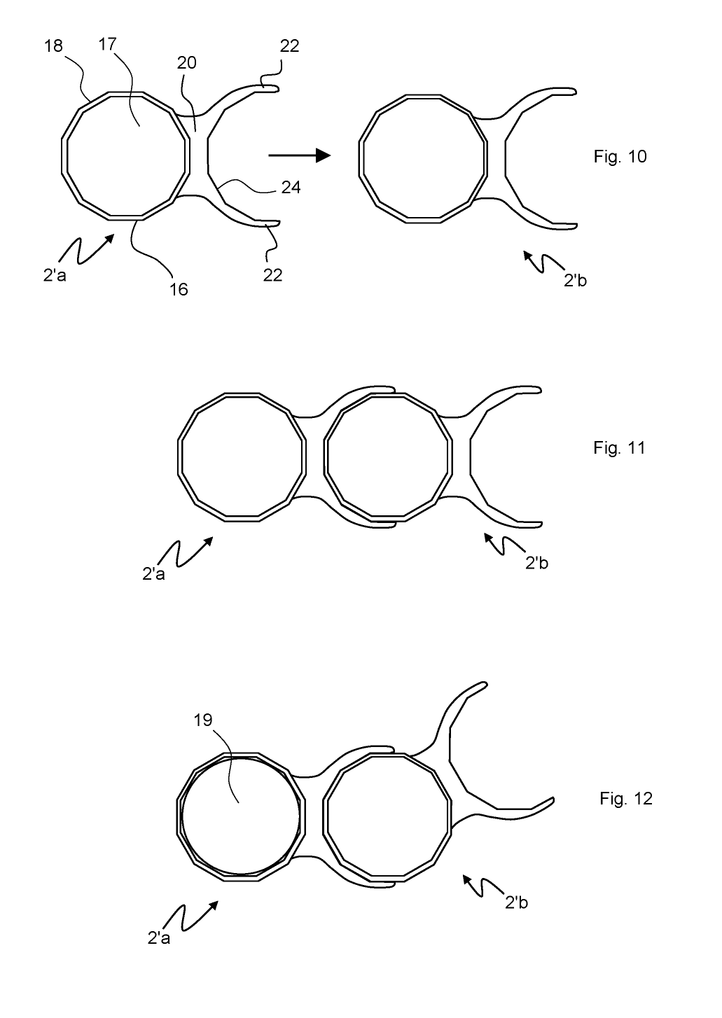

The modules can be constructed to temporarily retain adjacent modules in a particular angular orientation. In one arrangement the angular orientation can be temporarily maintained simply by a friction fit between the connection parts 6 and the outer surface of the body 4 of the adjacent module. But it will be readily appreciated that in some cases a friction fit will not be sufficient. For example, it might be necessary or desirable to increase the amount of force that needs to be applied by the user to move the adjacent modules to a particular angular orientation, and to thereby more securely retain the adjacent modules in the angular orientation. In one arrangement, one or both of the connection part and the outer surface of the body might be formed with engagement means or an engagement profile (e.g., a saw-tooth or ridged profile or the like) that still allows for relative rotation between the adjacent modules when the necessary amount of force is applied to overcome the engagement. Such engagement means might also allow for relative rotation in one direction (e.g., clockwise) while completely preventing relative rotation in the opposite direction (e.g., counter-clockwise). In one arrangement, shown in FIGS. 10 to 12, an alternative module 2′ includes a tubular body 16 made of a suitable plastics material and a pair of integral connection parts 20 each having a pair of arms 22. (It will be readily appreciated that only one of the connection parts 20 is visible in FIGS. 10 to 12 but that the overall construction of module 2′ is similar to the modules 2 shown in FIGS. 1 to 4.) Each body 16 has a hollow interior 17 with openings at both ends of the body. An engagement profile includes a series of flats or planar surfaces 18 around the circumference of each body 16 that are engaged by complementary planar surfaces 24 of the connection part of an adjacent module. The complementary planar surfaces 18, 24 prevent relative rotation (but permit lateral movement) between the adjacent modules to maintain the desired profile, and mean that adjacent modules can only be connected together at certain predetermined orientations. The predetermined orientations will depend on the number of flats or planar surfaces provided on each module.

In the arrangement shown in FIGS. 10 to 12 the body 16 has twelve planar surfaces 18 but any suitable number can be provided. The flats or planar surfaces can extend along the full axial length of the body, or can be provided only in the part of the body which is contacted by the connection part of the adjacent module. If engagement means are provided on one or both of the connection part and the outer surface of the body, such engagement means can be conveniently disengaged by disconnecting the modules from each other.

The engagement means or profile can also be used to prevent relative rotation between the adjacent modules unless the modules are unconnected and then re-connected in a different angular orientation, e.g., as shown in FIGS. 11 and 12 with adjacent modules 2′a and 2′b.

FIG. 12 also shows a separate heating unit 19 inserted into the hollow interior 17 of the body 16 of module 2′a. The heating unit 19 contains a thermal store, e.g., in the form of a non-toxic phase change material. The heating unit 19 is slid into the hollow interior 17 and is retained within the body 16 by friction line contact between the outer cylindrical surface of the heating unit and the inner planar surfaces of the body 16. In an alternative arrangement, the body 16 could have a cylindrical inner surface like the body 4 shown in FIGS. 1 to 5 whilst still retaining the planar outer surfaces 18.

It is convenient (from a point of view of manufacturing cost) if all of the modules have the same construction. FIGS. 4 and 5 show how the connection parts 6 can be formed so that they do not hinder relative rotation between the adjacent modules 2a, 2b. The connection parts 6 are asymmetrically located. The connection parts 6 are therefore not in register when the adjacent modules 2a, 2b are connected together in an opposite orientation. More particularly, each module has a first end 10a and a second end 10b. As shown in FIGS. 4 and 5, the first module 2a has its first end 10a on the left-hand side and its second end 10b on the right-hand side. The second module 2b has the opposite orientation, with its first end 10a on the right-hand side and its second end 10b on the left-hand side.

Because the connection parts 6 are not in register, the adjacent modules 2a, 2b can undergo relative rotation over a large angle, e.g., with reference to FIG. 3, until the connection part 6 of module 2b comes into contact with the outer surface of the body 4 of module 2a.

Although the connection parts 6 are shown as being relatively narrow, it will be readily appreciated that they can be formed with any suitable width. Other forms of connection means can also be provided, including those where the modules are integrally connected together and are not releasable, or where separate connection parts are provided and are used to connect adjacent pairs of modules together.

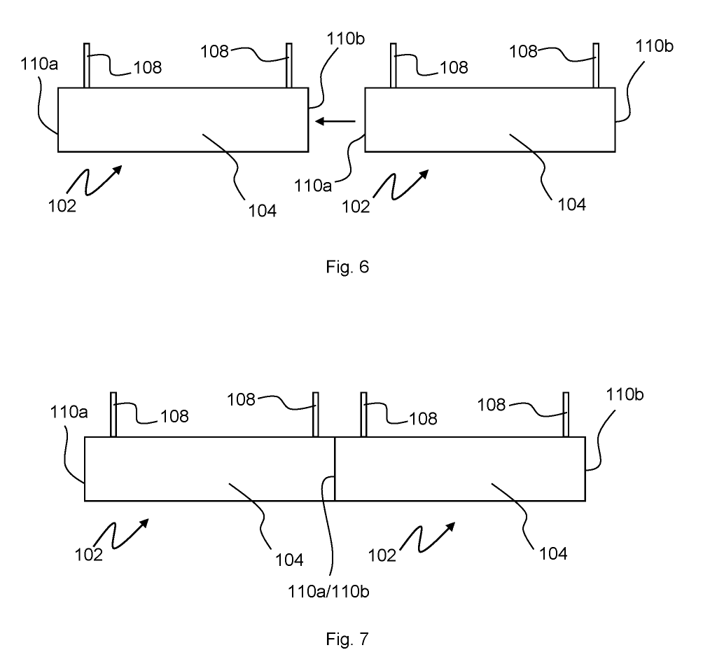

An alternative module 102 is shown in FIGS. 6 and 7. The alternative module 102 is similar to the module 2 described above and includes a substantially cylindrical tubular body 104 made of a suitable plastics material. The module 102 includes a pair of integral connection parts each having a pair of curved, resilient, arms 108. A plurality of modules 102 can be connected together using the connection parts as described above to form an assembly.

In addition to the resilient arms 108, each module 104 includes a male connector at a first end 110a and a female connector at a second end 110b. The male and female connectors 110a, 110b can have any suitable construction and allow modules to be releasably connected together end-to-end as shown in FIG. 7. When connected end-to-end the modules can define a longer hollow interior that can receive one or more heating or cooling units. It will be readily appreciated that the modules 102 can also be connected together side-by-side using the resilient arms 108 in the same manner as the modules 2. In one arrangement, a plurality of modules 102 can be connected together using the arms 108 to form a first sub-assembly and a plurality of modules can be connected together using the arms to form a second sub-assembly. The sub-assemblies can then be connected together using the male and female connectors 110a, 110b.

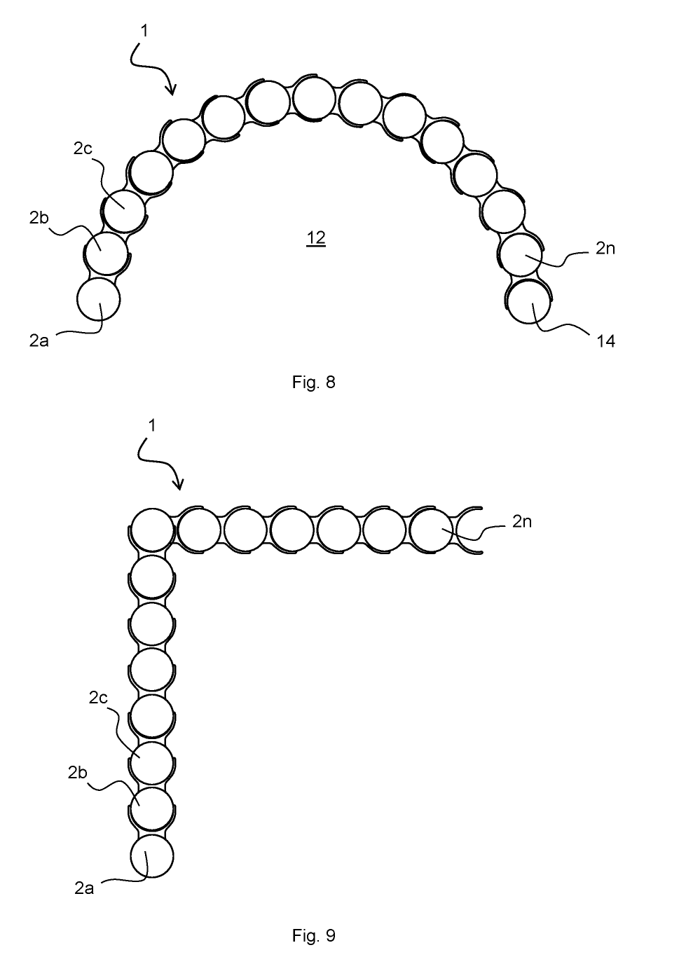

With reference to FIGS. 8 and 9, a pet hideaway 1 is constructed from a plurality of modules 2a-2n (or modules 102) all having the same construction and connected together as described above.

Once the modules have been connected together, they can be manipulated by the user to adopt different profiles.

FIG. 8 shows the pet hideaway 1 with a substantially ∩-shaped profile where the hideaway 1 forms an enclosed space 12 in which pets such as rabbits, guinea pigs, chinchillas, degus, hamsters etc. can conveniently shelter when the hideaway is placed in a hutch or enclosure. The hideaway 1 shown in FIG. 8 also includes an end module 14 with a substantially cylindrical body but no connection means. Such an end module 14 is entirely optional but makes the overall hideaway more symmetrical in appearance and can prevent the connection means 6 from being damaged.

FIG. 9 shows the hideaway 1 with a substantially L-shaped profile which can be fitted into a corner of a hutch or enclosure. (In FIG. 9 it will be understood that the hideaway 1 is being viewed from above, i.e., looking down towards the floor of the hutch or enclosure.)

In use, the modules 2a-2n are assembled together and manipulated to form a pet hideaway 1 with a desired profile. If heating is needed (e.g., during winter months) a separate heating unit can be inserted into one or more of the modules 2a-2n. The heating unit(s) will be heated using a microwave and once inserted into the pet hideaway will remain in a heated state for a period of time, during which the pet hideaway will provide useful heating. The heating unit(s) can be removed from the modules and re-heated as required.

If cooling is needed (e.g., during summer months) a cooling unit can be inserted into one or more of the modules 2a-2n in a similar way.

The pet hideaway 1 can be covered by a cover (not shown).

Insulating material can also be inserted into one or more of the modules 2a-2n to reduce heat loss through the pet hideaway 1.

What is claimed is:

1. A pet hideaway comprising a plurality of substantially tubular modules connected together by connection means.

2. The pet hideaway of claim 1, wherein the modules are releasably connected together by the connection means.

3. The pet hideaway of claim 1, wherein each module includes an integral connection part that allows it to be releasably connected to another module.

4. The pet hideaway of claim 1, wherein the connection means includes a plurality of separate connection parts, each connection part being releasably connected to at least one module.

5. The pet hideaway of claim 3, wherein each connection part and at least part of each module are provided with a complementary engagement profile or engagement means.

6. The pet hideaway of claim 5, wherein the engagement profile includes a series of planar surfaces around the circumference of each module and complementary planar surfaces on each connection part.

7. The pet hideaway of claim 1, wherein the connection means is adapted to substantially maintain the pet hideaway in the desired profile.

8. The pet hideaway of claim 1, further comprising at least one heating and/or cooling unit sized and shaped to be received within at least one module.

9. The pet hideaway of claim 8, wherein the at least one heating and/or cooling unit is slidably received within the at least one module.

10. The pet hideaway of claim 8, wherein the at least one heating and/or cooling unit contains a thermal store in the form of a solid, liquid or gel responsive to heating or cooling externally applied to at least part of the unit so that the solid, liquid or gel is heated or cooled, respectively, and remains in a heated or cooled state for a period of time after the externally applied heating or cooling is removed.

11. The pet hideaway of claim 10, wherein each heating and/or cooling unit includes a substantially-rigid body that encloses the solid, liquid or gel material of the thermal store.

12. The pet hideaway of claim 10, wherein the solid, liquid or gel of the thermal store is a phase change material.

13. The pet hideaway of claim 1, further comprising at least one heating unit sized and shaped to be received within at least one module, wherein the least one heating unit contains a supersaturated liquid or gel and means for allowing the user to selectively initiate crystallisation of the supersaturated liquid or gel to release heat energy for a period of time.

14. The pet hideaway of claim 13, wherein the at least one heating unit is slidably received within the at least one module.

15. A plurality of substantially tubular modules being adapted to be connected together to construct a pet hideaway that can be manipulated by a user to adopt a desired profile. The plurality of modules of claim 15, wherein each module has the same construction.

17. The plurality of modules of claim 15, wherein each module includes an integral connection part that allows it to be releasably connected directly to another module.

18. A kit comprising:
a plurality of substantially tubular modules being adapted to be connected together to construct a pet hideaway that can be manipulated by a user to adopt a desired profile; and
a plurality of connection parts, each connection part being adapted to be releasably connected to at least one module.

19. The kit of claim 18, further comprising at least one heating and/or cooling unit sized and shaped to be received within at least one module.
